(19) United States
(12) Patent Application Publication
(10) Pub. No.: US 2026/0211139 A1
(43) Pub. Date: Jul. 23, 2026

(54) SEISMIC TOMOGRAPHY FRAMEWORK

(71) Applicant: SCHLUMBERGER TECHNOLOGY CORPORATION, Sugar Land, TX (US)

(72) Inventor: Garret FLAGG, Houston, TX (US)

(21) Appl. No.: 19/138,841

(22) PCT Filed: Dec. 13, 2023
(86) PCT No.: PCT/US2023/083755

§ 371 Date: Jun. 13, 2025

Related U.S. Application Data
(60) Provisional application No. 63/477,402, filed on Dec. 28, 2022.

(51) Int. Cl. G01V 1/30; G01V 1/28

(52) U.S. Cl. CPC G01V 1/301; G01V 1/282; G01V 1/308; G01V 2210/612; G01V 2210/614; G01V 2210/6161

(57) ABSTRACT

A method can include receiving seismic data from a seismic survey of a subsurface geologic environment that includes one or more reflectors; performing a model-based iterative least squares inversion of the seismic data; for at least one iteration of the model-based iterative least squares inversion, determining a value of a regularization parameter by approximating a first function representative of a residuals norm and a second function representative of a solution norm, where the first function and the second function depend on the regularization parameter; and performing a subsequent model-based iterative least squares inversion of the seismic data using the regularization parameter to determine a position of at least one of the one or more reflectors.

### RELATED APPLICATION

This application claims priority to and the benefit of a US Provisional Application having Ser. No. 63/477,402, filed Dec. 28, 2022, which is incorporated by reference herein in its entirety.

### BACKGROUND

Reflection seismology finds use in geophysics to estimate properties of subsurface formations. Reflection seismology may provide seismic data representing waves of elastic energy as transmitted by P-waves and S-waves, in a frequency range of approximately 1 hertz (Hz) to approximately 100 Hz. In various instances, seismic data can also represent refractions and/or diving waves. Seismic data may be processed and interpreted to understand better composition, fluid content, extent and geometry of subsurface rocks. For example, a full-waveform inversion (FWI) may be implemented as part of a seismic data workflow for building a model of a subsurface environment where information from reflections, refractions and/or diving waves may be considered.

### SUMMARY

A method can include receiving seismic data from a seismic survey of a subsurface geologic environment that includes one or more reflectors; performing a model-based iterative least squares inversion of the seismic data; for at least one iteration of the model-based iterative least squares inversion, determining a value of a regularization parameter by approximating a first function representative of a residuals norm and a second function representative of a solution norm, where the first function and the second function depend on the regularization parameter; and performing a subsequent model-based iterative least squares inversion of the seismic data using the regularization parameter to determine a position of at least one of the one or more reflectors. A system can include a processor; memory operatively coupled to the processor; and processor-executable instructions stored in the memory to instruct the system to: receive seismic data from a seismic survey of a subsurface geologic environment that includes one or more reflectors; perform a model-based iterative least squares inversion of the seismic data; for at least one iteration of the model-based iterative least squares inversion, determine a value of a regularization parameter by approximating a first function representative of a residuals norm and a second function representative of a solution norm, where the first function and the second function depend on the regularization parameter; and perform a subsequent model-based iterative least squares inversion of the seismic data using the regularization parameter to determine a position of at least one of the one or more reflectors. One or more computer-readable storage media can include computer-executable instructions executable to instruct a computing system to: receive seismic data from a seismic survey of a subsurface geologic environment that includes one or more reflectors; perform a model-based iterative least squares inversion of the seismic data; for at least one iteration of the model-based iterative least squares inversion, determine a value of a regularization parameter by approximating a first function representative of a residuals norm and a second function representative of a solution norm, where the first function and the second function depend on the regularization parameter; and perform a subsequent model-based iterative least squares inversion of the seismic data using the regularization parameter to determine a position of at least one of the one or more reflectors. Various other examples of methods, systems, devices, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a geologic environment;

FIG. 2 illustrates examples of survey techniques;

FIG. 3 illustrates examples of survey techniques;

FIG. 4 illustrates examples of survey techniques;

FIG. 5 illustrates an example of forward modeling and an example of inversion;

FIG. 6 illustrates an example of a common image point reflection tomography process;

FIG. 7 illustrates an example of an equation and examples of data sizes;

FIG. 8 illustrates an example of an L-Curve and example equations;

FIG. 9 illustrates examples of equations for Krylov approximation;

FIG. 10 illustrates example plots of data for a curvature of an L-Curve;

FIG. 11 illustrates an example of a method and an example of a computing system;

FIG. 12 illustrates an example of a computational framework; and

FIG. 13 illustrates components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

As mentioned, reflection seismology finds use in geophysics to estimate properties of subsurface formations. Reflection seismology can provide seismic data representing waves of elastic energy, as transmitted by P-waves and S-waves, in a frequency range of approximately 1 Hz to approximately 100 Hz or optionally less than 1 Hz and/or optionally more than 100 Hz. Seismic data may be processed and interpreted to understand better composition, fluid content, extent and geometry of subsurface rocks.

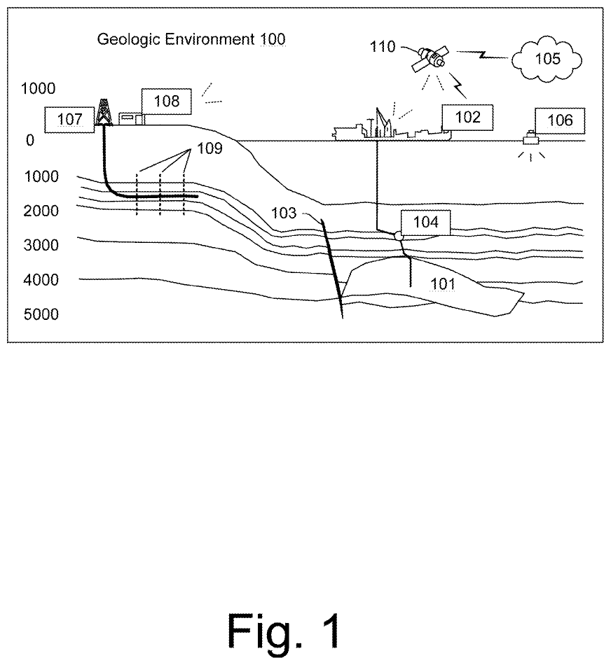

FIG. 1 shows a geologic environment 100 (an environment that includes a sedimentary basin, a reservoir 101, a fault 103, one or more fractures 109, etc.) and an example of an acquisition technique 140 to acquire seismic data (see data 160). A system may process data acquired by the technique 140 to allow for direct or indirect management of sensing, drilling, injecting, extracting, etc., with respect to the geologic environment 100. In turn, further information about the geologic environment 100 may become available as feedback (optionally as input to the system). An operation may pertain to a reservoir that exists in the geologic environment 100 such as the reservoir 101. A technique may provide information (as an output) that specifies one or more location coordinates of a feature in a geologic environment, one or more characteristics of a feature in a geologic environment, etc.

The geologic environment 100 may be referred to as a formation or may be described as including one or more formations. A formation may be a unit of lithostratigraphy such as a body of rock that is sufficiently distinctive and continuous.

A system may be implemented to process seismic data, optionally in combination with other data. Processing of data may include generating one or more seismic attributes, rendering information to a display or displays, etc. A process or workflow may include interpretation, which may be performed by an operator that examines renderings of information (to one or more displays, etc.) and that identifies structure or other features within such renderings. Interpretation may be or include analyses of data with a goal to generate one or more models and/or predictions (about properties and/or structures of a subsurface region).

A system may include features of a framework such as the PETREL seismic to simulation software framework (SLB, Houston, Texas). Such a framework can receive seismic data and other data and allow for interpreting data to determine structures that can be utilized in building a simulation model.

A system may include add-ons or plug-ins that operate according to specifications of a framework environment. As an example, a framework may be implemented within or in a manner operatively coupled to the DELFI cognitive exploration and production (E&P) environment (SLB, Houston, Texas), which is a secure, cognitive, cloud-based collaborative environment that integrates data and workflows with digital technologies, such as artificial intelligence and machine learning. As an example, such an environment can provide for operations that involve one or more frameworks.

Seismic data may be processed using a framework such as the OMEGA framework (SLB, Houston, TX). The OMEGA framework provides features that can be implemented for processing of seismic data through prestack seismic interpretation and seismic inversion.

A framework for processing data may include features for 2D line and 3D seismic surveys. Modules for processing seismic data may include features for prestack seismic interpretation (PSI), optionally pluggable into a framework such as the DELFI framework environment.

In FIG. 1, the geologic environment 100 includes an offshore portion and an on-shore portion. A geologic environment may be or include one or more of an offshore geologic environment, a seabed geologic environment, an ocean bed geologic environment, etc.

The geologic environment 100 may be outfitted with one or more of a variety of sensors, detectors, actuators, etc. Equipment 102 may include communication circuitry that receives and that transmits information with respect to one or more networks 105. Such information may include information associated with downhole equipment 104, which may be equipment to acquire information, to assist with resource recovery, etc. Other equipment 106 may be located remote from a well site and include sensing, detecting, emitting or other circuitry and/or be located on a seabed. Such equipment may include storage and communication circuitry that stores and that communicates data, instructions, etc. One or more satellites may be provided for purposes of communications, data acquisition, etc. FIG. 1 shows a satellite 110 in communication with the network 105 that may be configured for communications, noting that the satellite may additionally or alternatively include circuitry for imagery (spatial, spectral, temporal, radiometric, etc.).

FIG. 1 also shows the geologic environment 100 as optionally including equipment 107 and 108 associated with a well that includes a substantially horizontal portion that may intersect with one or more of the one or more fractures 109; consider a well in a shale formation that may include natural fractures, artificial fractures (hydraulic fractures) or a combination of natural and artificial fractures. The equipment 107 and/or 108 may include components, a system, systems, etc. for fracturing, seismic sensing, analysis of seismic data, assessment of one or more fractures, etc.

A system may be used to perform one or more workflows. A workflow may be a process that includes a number of worksteps. A workstep may operate on data to create new data, to update existing data, etc. A system may operate on one or more inputs and create one or more results based on one or more algorithms. A workflow may be a workflow implementable in the PETREL software that operates on seismic data, seismic attribute(s), etc. A workflow may be a process implementable in the DELFI environment, etc. A workflow may include one or more worksteps that access a plug-in (external executable code, etc.). A workflow may include rendering information to a display (a display device). A workflow may include receiving instructions to interact with rendered information to process information and optionally render processed information. A workflow may include transmitting information that may control, adjust, initiate, etc. one or more operations of equipment associated with a geologic environment (in the environment, above the environment, etc.).

As an example, an acquisition technique can be utilized to perform a seismic survey. A seismic survey can acquire various types of information, which can include various types of waves (e.g., P, SV, SH, etc.). A P-wave can be an elastic body wave or sound wave in which particles oscillate in the direction the wave propagates. P-waves incident on an interface (at other than normal incidence, etc.) may produce reflected and transmitted S-waves (“converted” waves). An S-wave or shear wave may be an elastic body wave in which particles oscillate perpendicular to the direction in which the wave propagates. S-waves may be generated by a seismic energy sources (other than an air gun). S-waves may be converted to P-waves. S-waves tend to travel more slowly than P-waves and do not travel through fluids that do not support shear. Recording of S-waves involves use of one or more receivers operatively coupled to earth (capable of receiving shear forces with respect to time). Interpretation of S-waves may allow for determination of rock properties such as fracture density and orientation, Poisson's ratio and rock type by crossplotting P-wave and S-wave velocities, and/or by other techniques. Parameters that may characterize anisotropy of media (seismic anisotropy) include the Thomsen parameters 8, 6 and y.

Seismic data may be acquired for a region in the form of traces. For example, a technique can utilize a source for emitting energy where portions of such energy (directly and/or reflected) may be received via one or more sensors (e.g., receivers). Energy received may be discretized by an analog-to-digital converter that operates at a sampling rate. Acquisition equipment may convert energy signals sensed by a sensor to digital samples at a rate of one sample per approximately 4 ms. Given a speed of sound in a medium or media, a sample rate may be converted to an approximate distance. The speed of sound in rock may be of the order of around 5 km per second. Thus, a sample time spacing of approximately 4 ms would correspond to a sample “depth” spacing of about 10 meters (m) (assuming a path length from source to boundary and boundary to sensor). A trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing scenario is divided by two (to account for reflection), for a vertically aligned source and sensor, the deepest boundary depth may be estimated to be about 10 km (assuming a speed of sound of about 5 km per second).

As mentioned, seismic data may be acquired and analyzed to understand better subsurface structure of a geologic environment. Reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz or optionally less than 1 Hz and/or optionally more than 100 Hz). Seismic data may be processed and interpreted, for example, to understand better composition, fluid content, extent and geometry of subsurface rocks.

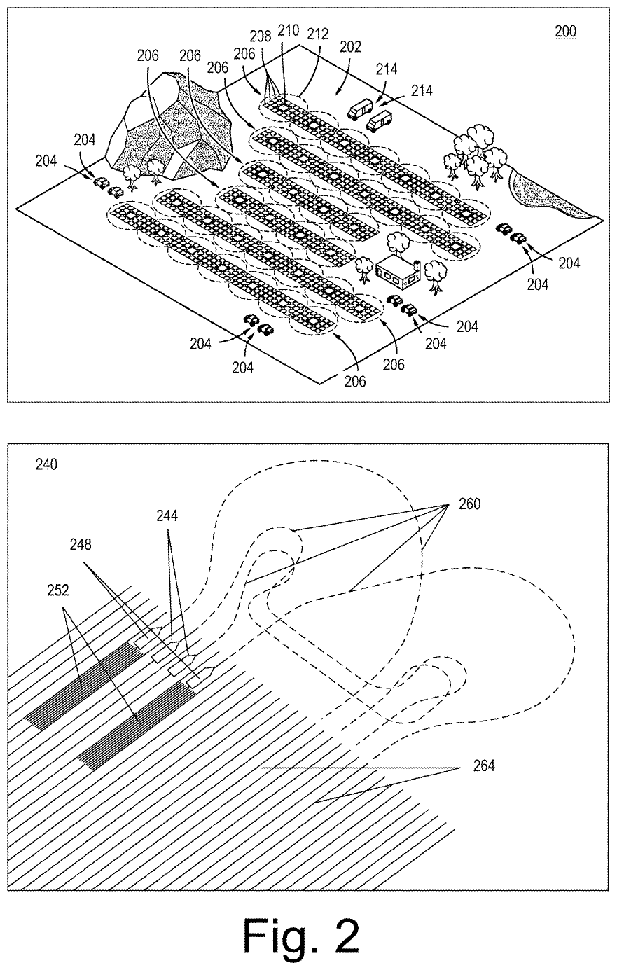

FIG. 2 shows an example of a simplified schematic view of a land seismic data acquisition system 200 and an example of a simplified schematic view of a marine seismic data acquisition system 240.

As shown with respect to the system 200, an area 202 to be surveyed may or may not have physical impediments to direct wireless communication between a recording station 214 (which may be a recording truck) and a vibrator 204. A plurality of vibrators 204 may be employed, as well as a plurality of sensor unit grids 206, each of which may have a plurality of sensor units 208.

As illustrated in FIG. 2 with respect to the system 200, approximately 24 to about 28 sensor units 208 may be placed in a vicinity (a region) around a base station 210. The number of sensor units 208 associated with each base station 210 may vary from survey to survey. Circles 212 indicate an approximate range of reception for each base station 210.

In the system 200 of FIG. 2, the plurality of sensor units 208 may be employed in acquiring and/or monitoring land-seismic sensor data for the area 202 and transmitting the data to the one or more base stations 210. Communications between the vibrators 204, the base stations 210, the recording station 214, and the seismic sensors 208 may be wireless (at least in part via air for a land-based system; or optionally at least in part via water for a sea-based system).

In the system 240 of FIG. 2, one or more source vessels 240 may be utilized with one or more streamer vessels 248 or a vessel or vessels may tow both a source or sources and a streamer or streamers 252. In the example of FIG. 2, the vessels 244 and 248 (e.g., or just the vessels 248 if they include sources) may follow predefined routes (e.g., paths) for an acquisition geometry that includes inline and crossline dimensions. As shown, routes 260 can be for maneuvering the vessels to positions 264 as part of the survey. As an example, a marine seismic survey may call for acquiring seismic data during a turn (e.g., during one or more of the routes 260).

The example systems 200 and 240 of FIG. 2 demonstrate how surveys may be performed according to an acquisition geometry that includes dimensions such as inline and crossline dimensions, which may be defined as x and y dimensions in a plane or surface where another dimension, z, is a depth dimension. As explained, time can be a proxy for depth, depending on various factors, which can include knowing how many reflections may have occurred as a single reflection may mean that depth of a reflector can be approximated using one-half of a two-way traveltime, some indication of the speed of sound in the medium and positions of the receiver and source (e.g., corresponding to the two-way traveltime).

Two-way traveltime (TWT) can be defined as the elapsed time for a seismic wave to travel from its source to a given reflector and return to a receiver (e.g., at a surface, etc.). As an example, a minimum two-way traveltime can be defined to be that of a normal-incidence wave with zero offset.

As an example, a seismic survey can include points referred to as common midpoints (CMPs). In multichannel seismic acquisition, a CMP is a point that is halfway between a source and a receiver that is shared by a plurality of source-receiver pairs. In such a survey, various angles may be utilized that may define offsets (e.g., offsets from a CMP, etc.). In a CMP approach, redundancy among source-receiver pairs can enhance quality of seismic data, for example, via stacking of the seismic data. A CMP can be vertically above a common depth point (CDP), or common reflection point (CRP). As an example, seismic data may be presented as a gather, which can be an image of seismic traces that share an acquisition parameter, such as a common midpoint gather (CMP gather or CMG), which contains traces having a common midpoint (CMP). In such an example, a CMG may be presented with respect to a horizontal dimension and a time dimension, which may be a TWT dimension.

As an example, a seismic survey can include points referred to as downward reflection points (DRPs). A DRP is a point where seismic energy is reflected downwardly. For example, where multiple interfaces exists, seismic energy can reflect upwardly from one interface, reach a shallower interface and then reflect downwardly from the shallower interface.

As an example, a seismic survey may be an amplitude variation with offset (AVO) survey. Such a survey can record variation in seismic reflection amplitude with change in distance between position of a source and position of a receiver, which may indicate differences in lithology and fluid content in rocks above and below a reflector.

AVO analysis can allow for determination of one or more characteristics of a subterranean environment (e.g., thickness, porosity, density, velocity, lithology and fluid content of rocks, etc.). As an example, gas-filled sandstone might show increasing amplitude with offset; whereas, a coal might show decreasing amplitude with offset. AVO analysis can be suitable for young, poorly consolidated rocks, such as those in the Gulf of Mexico.

As an example, a method may be applied to seismic data to understand better how structural dip may vary with respect to offset and/or angle as may be associated with emitter-detector (e.g., source-receiver) arrangements of a survey, for example, to estimate how suitable individual offset/angle gathers are for AVO imaging. As explained, a gather may be a collection of seismic traces that share an acquisition parameter, such as a common midpoint (CMP), with other collections of seismic traces. For example, consider an AVO survey that includes a plurality of emitter-detector arrangements (e.g., source-receiver pairs) with corresponding angles defined with respect to a common midpoint (CMP). Given a CMP, acquired survey data may be considered to cover a common subsurface region (e.g., a region that includes the midpoint).

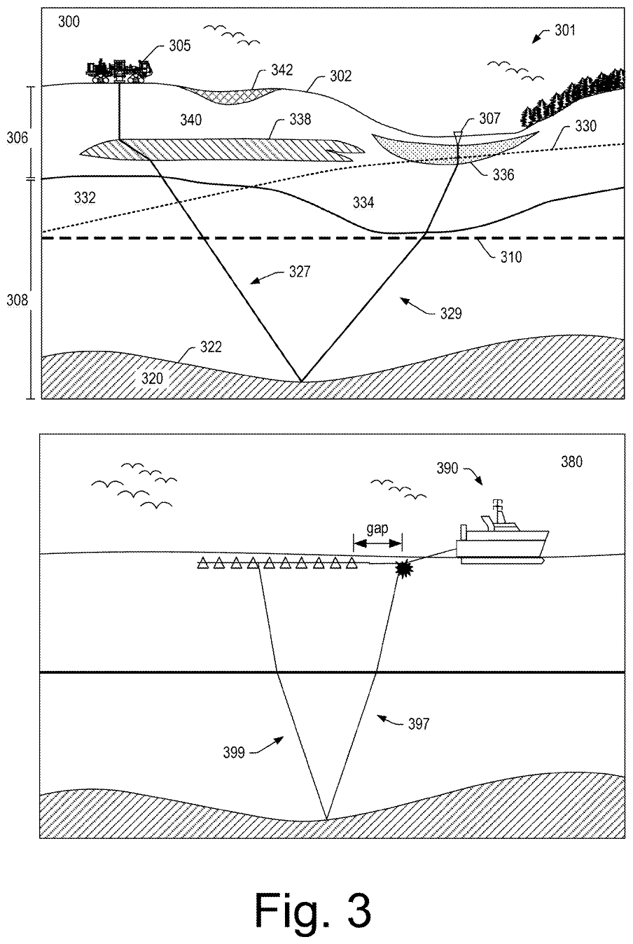

FIG. 3 shows an example of a land system 300 and an example of a marine system 380. The land system 300 is shown in a geologic environment 301 that includes a surface 302, a source 305 at the surface 302, a near-surface zone 306, a receiver 307, a bedrock zone 308 and a datum 310 where the near-surface zone 306 (e.g., near-surface region) may be defined at least in part by the datum 310, which may be a depth or layer or surface at which data above are handled differently than data below. For example, a method can include processing seismic data that aims to “place” the source 305 and the receiver 307 on a datum plane defined by the datum 310 by adjusting (e.g., “correcting”) traveltimes for propagation through the near-surface region (e.g., a shallower subsurface region).

In the example system 300 of FIG. 3, the geologic environment 301 can include various features such as, for example, a layer 320 that defines an interface 322 that can be a reflector, a water table 330, a leached zone 332, a glacial scour 334, a buried river channel 336, a region of material 338 (e.g., ice, evaporates, volcanics, etc.), a high velocity zone 340, and a region of material 342 (e.g., Eolian or peat deposits, etc.).

In FIG. 3, the land system 300 is shown with respect to downgoing rays 327 (e.g., downgoing seismic energy) and upgoing rays 329 (e.g., upgoing seismic energy). As illustrated the rays 327 and 329 pass through various types of materials and/or reflect off of various types of materials.

Various types of seismic surveys can contend with surface unevenness and/or near-surface heterogeneity. For example, a shallow subsurface can include large and abrupt vertical and horizontal variations that may be, for example, caused by differences in lithology, compaction cementation, weather, etc. Such variations can generate delays or advances in arrival times of seismic waves passing through them relative to waves that do not. By accounting for such time differences, a seismic image may be of enhanced resolution with a reduction in false structural anomalies at depth, a reduction in mis-ties between intersecting lines, a reduction in artificial events created from noise, etc.

As an example, a method can include adjusting for such time differences by applying a static, or constant, time shift to a seismic trace where, for example, applying a static aims to place a source and receiver at a constant datum plane below a near-surface zone. As an example, an amount by which a trace is adjusted can depend on one or more factors (e.g., thickness, velocity of near-surface anomalies, etc.).

In FIG. 3, the datum 310 is shown, for example, as a plane, below which strata may be of particular interest in a seismic imaging workflow. In a three-dimensional model of a geologic environment, a near surface region may be defined, for example, at least in part with respect to a datum. As an example, a velocity model may be a multidimensional model that models at least a portion of a geologic environment.

In the example of FIG. 3, the source 305 can be a seismic energy source such as a vibrator. As an example, a vibrator may be a mechanical source that delivers vibratory seismic energy to the Earth for acquisition of seismic data. As an example, a vibrator may be mounted on a vehicle (e.g., a truck, etc.). As an example, a seismic source or seismic energy source may be one or more types of devices that can generate seismic energy (e.g., an air gun, an explosive charge, a vibrator, etc.).

Vibratory seismic data can be seismic data whose energy source is a vibrator that may use a vibrating plate to generate waves of seismic energy. As an example, the frequency and the duration of emitted energy can be controllable, for example, frequency and/or duration may be varied according to one or more factors (e.g., terrain, type of seismic data desired, etc.).

As an example, a vibrator may emit a linear sweep of a duration that is of the order of seconds (e.g., at least seven seconds, etc.), for example, beginning with high frequencies and decreasing with time (downsweeping) or going from low to high frequency (upsweeping). As an example, frequency may be changed (e.g., varied) in a nonlinear manner (e.g., certain frequencies are emitted longer than others, etc.). In various vibrator scenarios, resulting source wavelet can be one that is not impulsive. As an example, parameters of a vibrator sweep can include start frequency, stop frequency, sweep rate and sweep length.

As an example, a vibrator may be employed in land acquisition surveys for areas where explosive sources may be contraindicated (e.g., via regulations, etc.). As an example, more than one vibrator can be used simultaneously (e.g., in an effort to improve data quality, etc.).

As an example, a receiver may be a may be a UNIQ sensor unit (SLB, Houston, Texas). As an example, a sensor unit can include a geophone, which may be configured to detect motion in a single direction. As an example, a geophone may be configured to detect motion in a vertical direction. As an example, three mutually orthogonal geophones may be used in combination to collect so-called 3C seismic data. As an example, a sensor unit that can acquire 3C seismic data may allow for determination of type of wave and its direction of propagation. As an example, a sensor assembly or sensor unit may include circuitry that can output samples at intervals of 1 ms, 2 ms, 4 ms, etc. As an example, an assembly or sensor unit can include an analog to digital converter (ADC) such as, for example, a 24-bit sigma-delta ADC (e.g., as part of a geophone or operatively coupled to one or more geophones). As an example, a sensor assembly or sensor unit can include synchronization circuitry such as, for example, GPS synchronization circuitry with an accuracy of about plus or minus 12.5 microseconds. As an example, an assembly or sensor unit can include circuitry for sensing of real-time and optionally continuous tilt, temperature, humidity, leakage, etc. As an example, an assembly or sensor unit can include calibration circuitry, which may be self-calibration circuitry.

In FIG. 3, the system 380 includes equipment 390, which can be a vessel that tows one or more sources and one or more streamers (e.g., with receivers). In the system 380, a source of the equipment 390 can emit energy at a location and a receiver of the equipment 390 can receive energy at a location. The emitted energy can be at least in part along a path of the downgoing energy 397 and the received energy can be at least in part along a path of the upgoing energy 399.

In various systems, for one or more reasons, a gap in coverage may exist. For example, in the system 380 a gap is identified and labeled where the gap may be defined as a distance between a seismic source and a seismic receiver. In such an example, the distance may be considered a practical or a safe distance for locating a seismic receiver from a seismic source. If a seismic receiver is too close to a seismic source, the seismic receiver may experience a rather large shock wave and/or may otherwise experience energy that may be quite high and raise concerns with calibration, dynamic range, etc.

In the examples of FIG. 3, the paths are illustrated as single reflection paths for sake of simplicity. In the environments illustrated, additional interactions, reflections can be expected. For example, ghosts may be present. A ghost can be defined as a short-path multiple, or a spurious reflection that occurs when seismic energy initially reverberates upward from a shallow subsurface and then is reflected downward, such as at the base of weathering or between sources and receivers and the sea surface. As an example, the equipment 390 can include a streamer that is configured to position receivers a distance below an air-water interface such that ghosts can be generated where upgoing energy impacts the air-water interface and then reflects downward to the receivers. In such an example, a process may be applied that aims to “deghost” seismic data. Deghosting can be applied to marine seismic survey data where such a process aims to attenuate signals that are downgoing from an air-water interface (i.e., sea surface interface). As mentioned, one or more other techniques, technologies, etc., may be utilized for seismic surveying (e.g., ocean bottom cables, ocean bottom nodes, etc.).

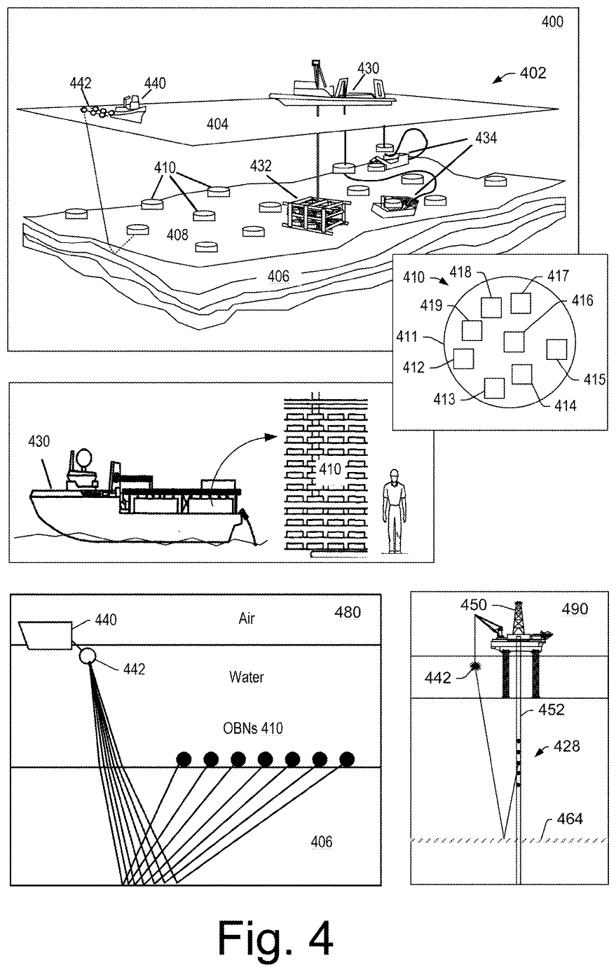

FIG. 4 shows a system 400 for acquisition of information in a geologic environment 402 that includes an air-water surface 404, a formation 406 and a seabed 408 (e.g., water-bed interface) where nodes 410 are positioned on the seabed 408. Equipment may be utilized to position the nodes 410 on the seabed 404 and retrieve the nodes 410 from the seabed 404. Such equipment may include one or more vessels 430, one or more carriers 432 and one or more vehicles 434, which may be autonomous, semi-autonomous, etc. (remotely operated vehicles (ROVs), etc.). The system 400 may include a seismic source vessel 440 that includes one or more seismic sources 442. The seismic source vessel 440 may travel a path while, at times, emitting seismic energy from the one or more sources 442. In such an approach, the nodes 410 can receive portions of the seismic energy, which can include portions that have travelled through the formation 406. Analysis of received seismic energy by the nodes 410 may reveal features of the formation 406.

In FIG. 4, the vessel 430 is shown as including nodes 410 as cargo arranged on racks. The nodes 410 can be deployed to form an array, for example, according to a survey plan. An array of nodes may be cabled or un-cabled. A cable may be relatively light weight and utilized to deploy a node receiver line with nodes coupled to the cable at spaced intervals. A rack can be utilized to securely store nodes in slots along multiple rows and columns. An individual slot may include a communications portal that can establish communication via contact(s) and/or contactless/wireless with an individual node seated in the individual slot for download of information, etc. A rack can include charger circuitry that can charge one or more batteries of an individual node seated in an individual slot. A node can be sealed such that components (circuitry, one or more batteries, etc.) are not exposed to water when the node is deployed on an underwater bed. A seal may be a hermetic seal that aims to prevent passage of air and/or water. A seal or seals can aim to prevent intrusion of water from an exterior region to an interior region of a node. Such a node can be considered to be water-tight. A sealed node can be a self-contained piece of equipment that can sense information independent of other equipment when positioned on an underwater surface that may be a seabed.

A rack may be dimensioned in accordance with shipping container dimensions such as about 3 meters by about 7 meters by about 3 meters. As shown in FIG. 4, with reference to a silhouette of a person that is about 1.8 meters in height, a node may be about a meter or less in diameter and about half a meter in height or less.

In FIG. 4, the one or more sources 442 may be an air gun or air gun array (a source array). A source can produce a pressure signal that propagates through water into a formation where acoustic and elastic waves are formed through interaction with features (structures, fluids, etc.) in the formation. Acoustic waves can be characterized by pressure changes and a particle displacement in a direction of which the acoustic wave travels. Elastic waves can be characterized by a change in local stress in material and a particle displacement. Acoustic and elastic waves may be referred to as pressure and shear waves, respectively; noting that shear waves may not propagate in water. Collectively, acoustic and elastic waves may be referred to as a seismic wavefield.

Material in a formation may be characterized by one or more physical parameters such as density, compressibility, and porosity. In the geologic environment 402 of FIG. 4, energy emitted from the one or more sources 442 can be transmitted to the formation 406; however, elastic waves that reach the seabed 408 will not propagate back into the water. Such elastic waves may be received by sensors of the nodes 410. The nodes 410 can include motion sensors that can measure one or more of displacement, velocity and acceleration. A motion sensor may be a geophone, an accelerometer, etc. As to pressure waves, the nodes 410 can include pressure wave sensors such as hydrophones.

In FIG. 4, the nodes 410 can include sensors for acquiring seismic wavefield information at the seabed 408. Each of the nodes 410 can include one or more hydrophones and/or one or more motion sensors (one or more geophones, one or more accelerometers, etc.).

A node can include various types of circuitry. Such circuitry can include circuitry that can digitize (analog to digital conversion ADC circuitry) and can include circuitry that can record signals (a microcontroller, a processor, etc., operatively coupled to memory). Each of the nodes 410 can include a housing 411, sensors 412 and 413, one or more microcontrollers or processors 414, one or more batteries 415, memory 416, ADC circuitry 417, a compass 418, communication circuitry 419, etc. As an example, a node can include one or more clocks, which may be amenable to calibration, synchronization, etc. For example, consider synchronizing to a signal, calibrating against a value, etc. As an example, a node can provide for receiving seismic energy and generating digital data that can be coded or otherwise stamped with information corresponding to time (e.g., according to one or more clocks). Various components of a node may be operatively coupled via wires, connectors, etc. A node can include one or more circuit boards (printed circuit boards, etc.) that can provide for electrical connections between various components, etc.

After deployment, one or more acoustic techniques may be utilized to determine node locations. A technique may employ acoustic pinging where acoustic pingers emit relatively high-frequency pings that are substantially above the maximum frequency of interest for seismic applications. Such relatively high-frequency acoustic signals can be picked up by one or more seismic sensors. Triangulation or one or more other techniques may be utilized to determine node locations for nodes deployed on an underwater surface such as a seabed.

Nodes may be utilized to acquire information spatially and temporally such as in a time-lapse seismic survey, which may be a four-dimensional seismic survey (4D seismic survey). A seismic image of a formation may be made for a first survey and a seismic image of the formation may be made for a second survey where the first and second surveys are separated by time (lapse in time). In such an approach, a comparison of the images can infer changes in formation properties that may be tied to production of hydrocarbons, injection of water or gas, etc.

A first survey may be referred to as a baseline survey, while a subsequent survey may be referred to as a monitor survey. To minimize artifacts in differences between seismic images from successive lapses, a monitor survey may aim to replicate a configuration of a corresponding baseline survey. Where nodes are utilized at various positions on a seabed for a baseline survey, a monitor survey may aim to place nodes on the seabed in a manner that replicates the various positions of the nodes of the baseline survey. For the monitor survey, the nodes may be the same nodes, include some of the same nodes, include some different nodes or may be different nodes. A service may have a stock of nodes that can be utilized for various surveys where once a survey is complete, the nodes are retrieved, transported and positioned for another survey. Such a service may update, replace, etc., nodes from time to time.

A position to within a few meters of accuracy of one or more nodes may be determined via one or more of GPS, an acoustic positioning system (a short-baseline (SBL) or ultra-short baseline (USBL) acoustic system), and one or more other types of systems.

A node can include sensor circuitry for acquiring measurements of a seismic pressure wavefield and its gradient; consider sensor circuitry that can measure a seismic pressure wavefield and its gradient in vertical and crossline directions.

A node can include point-receiver circuitry. A point-receiver approach can combine hydrophones with tri-axial microelectromechanical system (MEMS) accelerometers. In such an approach, the MEMS accelerometers can measure a substantial bandwidth of particle acceleration due to seismic wavefields. Measurements of particle acceleration can be directly related to a gradient in a pressure wavefield. A node may include the ISOMETRIX technology, which includes point-receiver circuitry (SLB, Houston, Texas).

In the example of FIG. 4, one of the nodes 410 may be connected to one or more other nodes of the nodes 410 via a cable. A vessel may include a cable that is operatively coupled to at least one node. In the system 400 of FIG. 4, nodes may be deployed according to a survey plan in a grid pattern; consider placement of nodes on a seabed according to an x,y grid where distance between adjacent nodes may be of the order of hundreds of meters. As shown in the system 400, the seismic source vessel 440 may be employed with the one or more sources 442 that can emit energy, which can, in turn, be received via one or more of the nodes 410.

As an example, a common shot approach 480 may be utilized, as illustrated via the formation 406, the OBNs 410, the seismic source vessel 440 and the one or more sources 442. As explained, the vessel 440 can tow one or more sources at or below an air-water interface where the OBNs 410 can be positioned on a water-formation interface (e.g., a seafloor, seabed, ocean bottom, sea bottom, etc.). As shown, the energy of the source or the sources 442 passes through the water and then into the formation 406 where a portion of the energy is reflected at an interface (e.g., a reflector). As shown, energy can reflect off the interface and progress upwardly to the OBNs 410, which can be receivers that record the energy.

When seismic traces of a gather come from a single shot and many receivers, they can form a common shot gather; whereas, a single receiver with many shots can form a common receiver gather. A shot gather is a plot of traces with respect to line distance (e.g., an inline or a crossline series of receivers) with respect to time. Such a plot may be referred to as an image, which includes information about a subsurface region; noting that traces may be processed to generate one or more other types of images of a subsurface region.

Also shown in FIG. 4 is an inset of a zero-offset vertical seismic profile (VSP) scenario 490. In such a scenario, an acquisition geometry may be limited to an ability to position equipment that is physically coupled to a rig 450. As shown, for given the acquisition geometry, there may be no substantial offset between the source 442 and a bore 452. In such a scenario, a zero-offset VSP may be acquired where seismic waves travel substantially vertically down to a reflector (see the layer 464) and up to receivers 428, which may be a receiver array. Where one or more vessels are employed, one or more other types of surveys may be performed. A three-dimensional VSP may be performed using a vessel. As an example, a VSP may be performed using one or more nodes, etc.

Some examples of techniques that can process seismic data include migration and migration inversion, which may be implemented for purposes such as structural determination and subsequent amplitude analysis. In seismic exploration, signal can be defined as a part of a recorded seismic record (e.g., events) that is decipherable and useful for determining subsurface information (e.g., relevant to the location and production of hydrocarbons, etc.). Migration and migration inversion are techniques that can be used to extract subsurface information from seismic reflection data.

As an example, a migration technique can include predicting a coincident source and receiver at depth at a time equal to zero; an approach that may be extended for heterogeneous media and to accommodate two-way propagation in a local sense at points from the source to a target reflector and back from the reflector to the receiver and in a global sense, separately for each of the two legs from the source to the reflector and from the reflector to the receiver. Such an approach for two-way wave propagation migration may provide for quantitative and definitive definition of the roles of primaries and multiples in migration where, for example, migration of primaries can provide subsurface structure and amplitude information.

Various techniques that can be used to predict a wavefield inside a volume from values (e.g., measured values) of a field on a surface surrounding the volume can involve using Green's theorem. Green's theorem may be implemented, for example, as part of a process for a finite volume model prediction of the so-called “source and receiver experiment” for two-way waves at depth. As an example, Green's theorem can predict a wavefield at an arbitrary depth z between a shallower depth “a” and a deeper depth “b”.

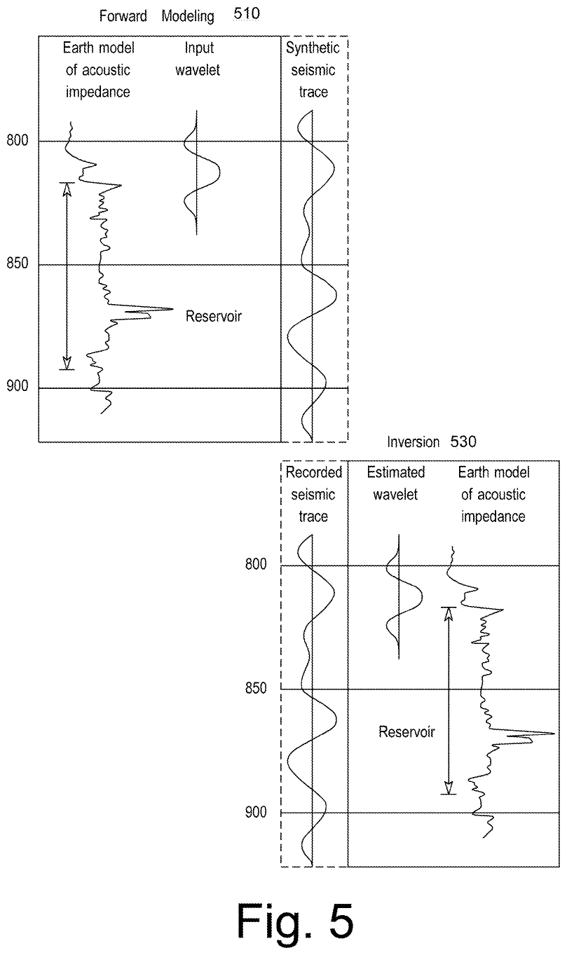

FIG. 5 shows an example of forward modeling 510 and an example of inversion 530 (e.g., an inversion or inverting). As shown, the forward modeling 510 progresses from an earth model of acoustic impedance and an input wavelet to a synthetic seismic trace while the inversion 530 progresses from a recorded seismic trace to an estimated wavelet and an Earth model of acoustic impedance. As an example, forward modeling can take a model of formation properties (e.g., acoustic impedance as may be available from well logs) and combine such information with a seismic wavelength (e.g., a pulse) to output one or more synthetic seismic traces while inversion can commence with a recorded seismic trace, account for effect(s) of an estimated wavelet (e.g., a pulse) to generate values of acoustic impedance for a series of points in time (e.g., depth).

Acoustic impedance is the opposition of a medium to a longitudinal wave motion. Acoustic impedance is a physical property whose change determines reflection coefficients at normal incidence, that is, seismic P-wave velocity multiplied by density. Acoustic impedance characterizes the relationship between the acting sound pressure and the resulting particle velocity.

During the propagation of seismic wave along a ray path, a seismic wave transmits through and/or reflects at a material boundary and/or converts its vibration mode between P-wave and S-wave. An observed amplitude of a seismic wave depends on an acoustic impedance contrast at a material boundary between two media (e.g., consider an upper medium and a lower medium). Acoustic impedance, Z, can be defined by a multiplication of density, p, and seismic velocity, Vp, in each media. Acoustic impedance Z tends to be proportional to Vp for the many sedimentary and crustal rocks (e.g., granite, anorthite, pyrophyllite, and quartzite), except for some ultramafic rocks (e.g., dunite, eclogite, and peridotite) in the mantle.

In various instances, an inversion problem may be ill-posed for one or more reasons. Recorded data can include discrepancies including, for example, missing data near offsets (e.g., due to gaps, etc.), and multiple events with other artifacts that contaminate the model of primaries that is inverted for. Artifacts can also be associated with inversion inaccuracies coming from inaccurate physics simulation (e.g., inversion of 3D data using 2D inversion, wavelet estimation errors, etc.).

For various reasons, a seismic survey may have coverage issues. For example, certain subsurface structures may impact “illumination” of one or more regions by seismic energy. In seismology, illumination can refer to an ability for seismic energy to fall on a reflector and thus be available to be reflected. Illumination can depend on source-receiver configuration (e.g., a survey geometry) and velocity distribution such as, for example, irregular velocity contrasts that may bend raypaths differently than adjacent raypaths. Various regions can have complicated velocity variations, for example, consider high-velocity contrast regions and subsalt regions.

A subsalt region can be an exploration and production play type in which prospects exist below salt layers. Prospecting for such regions below salt layers can pose challenges with respect to illumination, which may result in seismic data of poor quality. The Gulf of Mexico includes subsalt-producing fields; noting that subsalt regions also exist in other parts of the world such as, for example, offshore Brazil in the Santos, Campos and Espirito Santo basins.

A region below salt (e.g., a subsalt region) may be referred to as a pre-salt layer. As an example, a region may include a diachronous series of geological formations on a continental shelve of an extensional basin formed after the break-up of Gondwana, which may be characterized by deposition of thick layers of evaporites that can be composed mostly of salt. In various regions, some petroleum generated from sediments in a pre-salt layer may not have migrated upward to post-salt layers above, for example, due to one or more salt domes. Such types of regions exist off the coast of Africa and the coast of Brazil. Total pre-salt hydrocarbon reserves are estimated to be a substantial fraction of the world's hydrocarbon reserves.

Off the coast of Brazil, oil and natural gas reserves lie below an approximately 2,000 m (6,600 feet (ft)) thick layer of salt, which in turn is beneath more than 2,000 m (6,600 ft) of post-salt sediments in places, which in turn is under water depths between 2,000 m and 3,000 m (6,600 ft and 9,800 ft) in the South Atlantic. Drilling through rock and salt to extract pre-salt oil and gas can be complicated and costly. As explained, seismic surveying can be challenging in such regions, which can introduce uncertainties in planning, drilling, etc.

As an example, a technique referred to as common image point reflection tomography (CIP-tomo) may be utilized for imaging complex or otherwise challenging geological environments. Consider geologic environments such as, for example, complex salt environments in the Gulf of Mexico, offshore West Africa, and Brazil; fault shadows and gas clouds in offshore Southeast Asia, Australia, and the North Sea; permafrost conditions in Alaska and Siberia; and mud volcanoes in the Caspian Basin.

As an example, CIP-tomo may utilize a 3D grid and a multiscale approach to generate subsurface images of suitable quality and resolution using marine, land, and/or ocean bottom seismic data and survey geometries to produce detailed, accurate anisotropic earth models. As explained, an inversion process can generate an earth model based on seismic data such as, for example, seismic trace data.

CIP-tomo is a generalized reflection tomography method that uses residual moveout (RMO, residual curvature) analysis of prestack depth-migrated CIP gathers to update an initial model. Multiparameter (e.g., nonhyperbolic, general, or nonparametric) RMO may be automatically estimated from offset vector tile or angle gathers. As an example, an input model can be a space-partitioned hybrid model representation that enables isolation of different geologic units in a model space. Such an approach can facilitate the application of geological and other constraints and the implementation of multilayer tomography. In addition, CIP-tomo can support the application of flexible weighting schemes. For challenging subsalt areas, CIP-tomo can provide the capability to update from migration scan input.

CIP-tomo can be suitable for both compaction-driven (e.g., where velocity heterogeneity is dominated by a compaction gradient) and layered (e.g., where velocity heterogeneity is dominated by lithology or age) geologic environments. Its multilayer capability can be flexible and enable inverting for property updates in specific layers or zones. CIP-tomo can account for transversely isotropic media and orthorhombic media with a vertical or tilted axis of symmetry, with different combinations of parameters updated as appropriate. Depending on geology, data type (e.g., including converted modes), and anisotropy class, a suitable tomographic inversion scheme can be applied to optimize results.

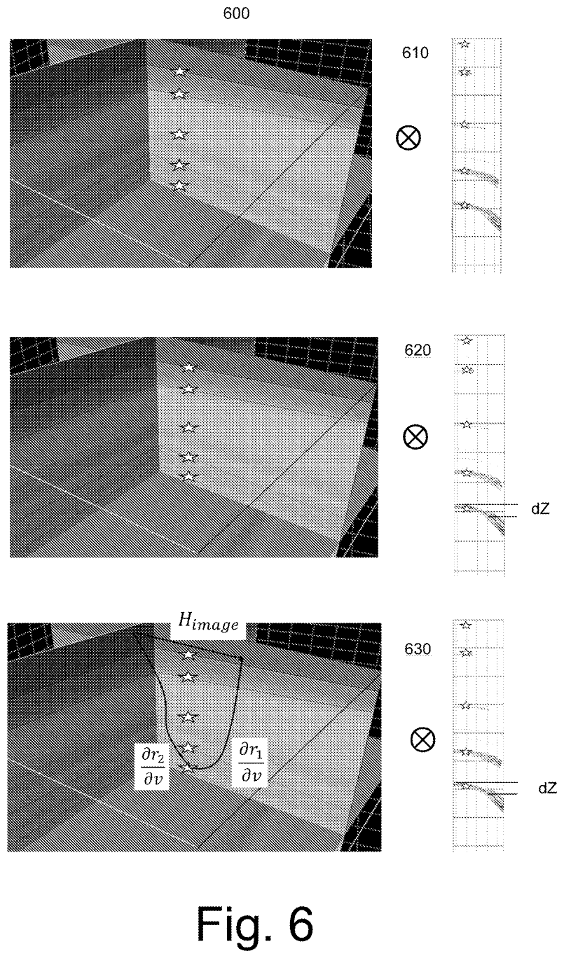

FIG. 6 shows an example of a method 600 that includes various processes 610, 620 and 630 for performing various aspects of CIP-tomo. As shown, a geologic environment can include stratigraphic layers represented by associated properties that may be rendered to a display, for example, as part of a graphical user interface. In such an example, shading, colors, etc., may be utilized to indicate different property values within the geologic environment. As explained, layers may differ in property values such that seismic energy is at least in part reflected at a layer boundary, which may be, for example, a horizon or another type of subsurface feature. In reflection tomography, seismic energy may be utilized to characterize subsurface features, which, in turn, may be utilized to build, adjust, etc., one or more models of a geologic environment. For example, a multidimensional earth model can be constructed where acoustic properties can be assigned to various layers such that the multidimensional earth model can be a velocity model. A velocity model can be a single dimensional model or a multidimensional model that provides a spatial distribution of velocity in a subsurface environment. For example, consider a model that uses constant-velocity units (layers), through which raypaths obeying Snell's law can be traced. As mentioned, acoustic impedance and velocity are related and, as explained with respect to FIG. 5, a model (e.g., acoustic impedance and/or velocity) can be utilized for forward modeling and/or inversion (e.g., inverting). In various instances, a method may be iterative where, for example, a model is refined until a suitable match is achieved between the model and data (e.g., seismic data, well log data, etc.).

In the example of FIG. 6, a model is rendered with positions of reflectors (e.g., interfaces between layers) where various reflectors are indicated by stars along a depth dimension, in particular, five reflectors are indicated as examples. As explained, a seismic survey can utilize a source and receivers where spatial offsets (e.g., offsets) are known between the source and each of the receivers. In such a survey, each receiver acquires seismic data (e.g., traces), from emitted seismic source energy that interacts with the reflectors, from a different perspective (e.g., due to the offsets). As shown in FIG. 6, to the right of the multidimensional rendering of the model, an offset gather image can be reconstructed from the acquired data where the offset gather image can be a spatial seismic image with dimensions of depth (vertical axis) and offset (horizontal axis). As mentioned, positions of the reflectors in the model are indicated by stars where corresponding stars are shown in the offset gather image. In the example of FIG. 6, a gather can be defined as an image of seismic traces that share an acquisition parameter, such as, for example, a common midpoint gather (CMP gather), which contains traces having a common midpoint (CMP).

In the offset gather images, the actual depths of the reflectors can be estimated by inversion, for example, using an initial model and seismic data. As explained, such a process can be iterative such that model updates occur until error between the model and the seismic data with respect to reflector locations is minimized.

In the example of FIG. 6, for a given reflector position as indicated by a corresponding star, a depth parameter, dz, can be determined as a tomographic output. The depth parameter, dz, can be a constraint that represents a change in a z position of a star. As the model is updated, the depth parameter, dz, for each of a number of stars, is minimized (e.g., driven near or to zero). Hence, after a number of iterations, the depth parameter, dz, for each of the reflectors may be expected to be reduced in magnitude such that upon further iterations improvements in depth estimates become relatively small, which may be negligible. In such an example, further iterations may waste computational resources and/or increase numerical error (e.g., consider numerical round-off error, etc.).

As an example, rows of a tomography equation matrix can be derived from ray shooting with respect to a model. In the process 630 of the method 600, a left side ray and a right side ray are shown for one of the stars, which is the deepest star, where these two rays are shown with respect to a vector that represents an offset between a source and a receiver. Such ray shooting generates information to populate the tomography equation matrix. As shown, for each ray, the process 630 can derive depth with respect to material property information (e.g., acoustic properties), which are shown as

$$\frac{\partial {r}_{1}}{\partial v} and \frac{\partial {r}_{2}}{\partial v}$$

for the left ray (source to reflector) and the right ray (reflector to receiver), respectively.

As an example, a tomography equation matrix can include rows where each row represents changes in material properties at a particular reflection point. A solution vector with property parameters, dp, can represent the “best” change in the material property values that will match the change in the depth differences per the depth parameters, dz, where the goal is to drive the depth differences toward zero (e.g., drive the values of the depth parameters, dz, to close to zero, to zero or below a threshold value that may operate as a stopping criterion, etc.).

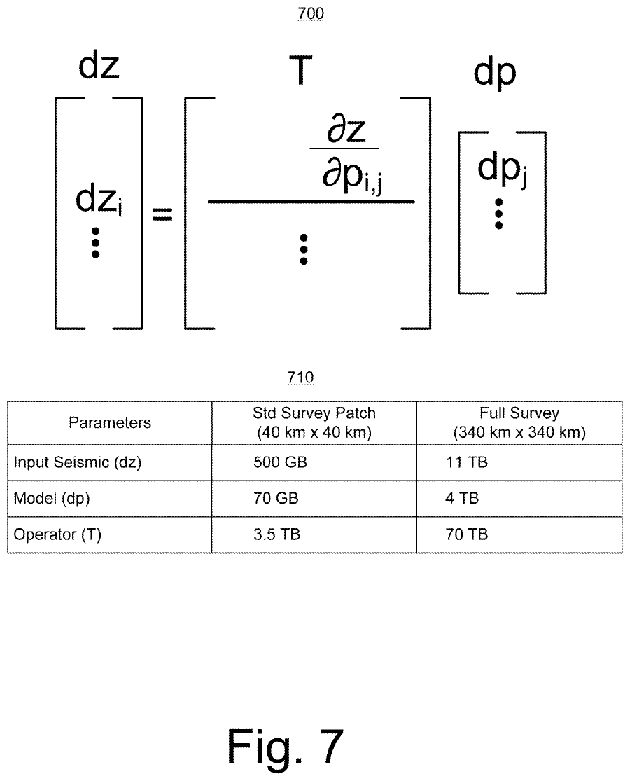

FIG. 7 shows an example of a tomography equation 700 that includes a vector dz (e.g., depth parameter), a matrix T (e.g., operator) and a vector dp (e.g., property parameter). FIG. 7 also shows an example of a table 710 with data storage sizes for the tomography equation 700. For example, the input seismic vector for the depth parameters, dz, can be from hundreds of gigabytes (GB) to more than 10 terabytes (TB), the model vector for the property parameters, dp, can be from tens of GB to more than several TB, and the matrix or operator, T, can be from a TB to tens of TB. In the example of FIG. 7, the sizes are given as examples, noting that sizes may be greater and/or smaller. Further, in the example of FIG. 7, the sizes of the patch and the full survey may be greater and/or smaller.

As explained with respect to FIG. 6 and FIG. 7, obtaining subsurface earth model estimates from tomography can involve generating a solution to a large-scale linear least squares problem. In various instances, the sheer size of the problem is a driving constraint for developing practical methods of constructing the solution. In various instances, such a problem tends to be ill-posed and underdetermined, and therefore demands imposition of additional constraints, which can be or include regularization constraints, to obtain a proper solution.

In various instances, a solution to a problem can also be complicated by null space issues (e.g., moving into or away from a null space). Null space issues arise due to the actual physics of a seismic survey and an earth model. Accordingly, null space issues can be tied to real-world physics. As a boundary value problem, such a problem can be ill-posed with multiple solutions. In various instances, a large portion of the null space is numerically null due to the seismic experiment generating a substantial amount of data that does not change substantially between source and receiver pairs, which can effectively result in a large number of redundant equations. As explained, an earth model aims to represent an actual geologic environment where over large regions within that actual geologic environment, however, variation in material properties can be minimal. Again, as mentioned, reflection seismology (e.g., reflection tomography) relies on interfaces (e.g., reflectors), which, spatially, occupy a small volume of an actual geologic environment relative to the cumulative large volume of the bulk of each of the layers that form respective interfaces. In comparison to medical imaging of the human body, the human anatomy of various regions of the human body can be very complex and spatially varying at a small scale such that a null space may be minimal compared to varying structural features (e.g., material properties) in a geologic environment. As such, due to the manner in which a geologic environment is formed (e.g., according to depositional theory, etc.) reflection seismology poses some types of challenges not found in various other types of imaging (e.g., X-ray tomography of a human, etc.). In various instances, frequency content of a seismic tomography problem can also be a factor. Inherently, seismic reflection tomography relies on distributed, interconnected equipment due to the volume of the geologic environment being studied; whereas, in contrast, an X-ray computerized tomography system for human imaging may fit into a room or adjacent rooms of a medical facility. In comparison, conditions within a medical facility may be constructed and/or otherwise be well-controlled; whereas, performance of seismic tomography may have to deal with many environmental variables (e.g., wind, sun, lighting, variations in terrain, surface waves in bodies of water, etc.). In X-ray computerized tomography, a patient generally goes to a medical facility where the patient may be inserted into an imaging tube such that radiation can be introduced from a full 360 degrees; whereas, in reflection tomography, the system goes to a surface of the environment to be imaged where a range of angles of irradiation may be practically limited.

In seismic tomography, to make an inversion process efficient, with respect to a least-squares solution approach, a method can determine a parameter set for an operator that can reduce reliance on using a guess and check approach.

As an example, a constraint can be in the form of a free parameter such as the Tychonoff regularization parameter. This regularization parameter is a scalar value between 0 and 1 that a user chooses per each run of a tomography process to obtain a solution (e.g., in a guess and check approach). As each run of a tomography process is computationally expensive, it can be quite costly to try several different values of a regularization parameter (e.g., guess and check). The value of the Tychonoff regularization parameter facilitates handling of issues such as issues arising from a null space (e.g., regulation or control of the null space), which governs how large the norm of a solution vector can be. And, the further a solution proceeds into a null space of the operator (e.g., matrix), the larger the norm of the solution vector becomes. Further, as seismic tomographic data and an earth model are digital representations that are to approximate an actual physical environment, there is no discrete cutoff as to the null space (e.g., exact rank and numerical rank).

As an example, a tomography framework can invert seismic data to generate an earth model using a method that automatically provides an improved choice of parameterization by leveraging an analysis of an accurate approximation to the behavior of solutions as a function of the Tychonoff regularization parameter.

As an example, a framework may provide for properly choosing the Tychonoff parameter A which optimally regularizes the solution to the problem:

$${min}_{x} {‖ Ax - b ‖}^{2} + λ {‖ x ‖}^{2}$$

The foregoing problem can demand experience in applying linear inversion methods in a particular context (e.g., understanding the details of a desirable solution for the particular physical problem) and some requisite knowledge of the neighborhood of the best choice of λ. As mentioned, a method can automate a process of finding a neighborhood for choosing the “best” choice of λ by proposing an “optimal” value for λ which will ordinarily not demand adjustment.

As an example, a method can implement and apply the L-Ribbon approximation to the L-Curve for a reflection tomography problem. The L-Curve, parameterized by the Tychonoff parameter λ, is given as:

$$( log ( ‖ ( A + λ I ) x - b ‖ ) , log ( ‖ {x}_{λ} ‖ ) ) .$$

Explicitly forming this curve, and choosing the best value of λ on the basis of the curvature of this curve would be extremely expensive both in terms time and computational cost and is not possible.

In the context of tomography, this approximation can be constructed with only a few (<20) iterations of the Lanczos Bidiagonalization, and is several orders of magnitude cheaper in terms of time and computational cost (e.g., <10 seconds versus hours of compute time). As described herein, a framework can efficiently form the L-Ribbon approximation and use it to automatically compute an optimal value of λ.

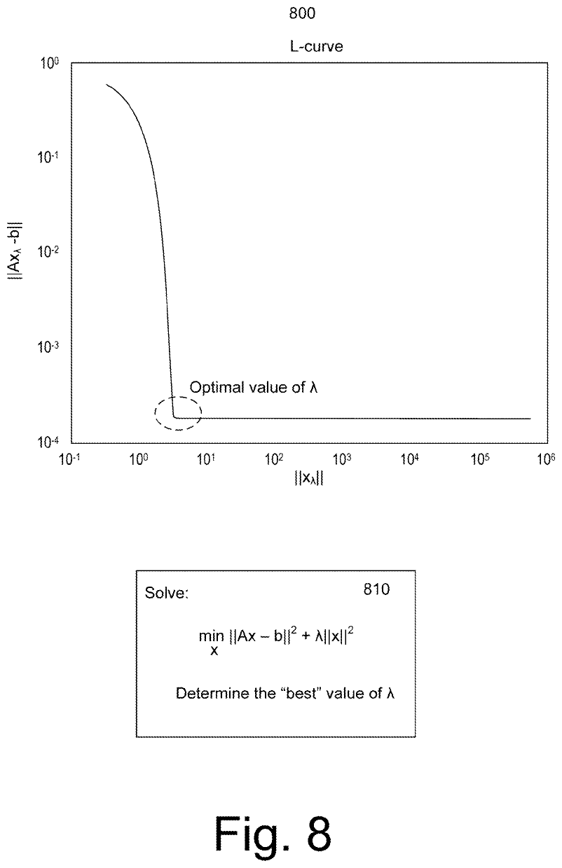

FIG. 8 shows an example of an L-Curve 800 and an example solution procedure 810, summarized as solving an equation to minimize x by choosing the best value of the Tychonoff parameter λ. As shown, the L-Curve 800 is defined by a vertical axis and a horizontal axis using portions of the equation where the optimal value of the Tychonoff parameter λ is at a bend in a curve (see, e.g., bend within a dashed oval), which has a substantially L-shape. Given unlimited resources and time, a guess and check approach, an L-Curve such as the L-Curve 800 can be computed to find a trade-off location where the norm of the residual (see y-axis of the L-Curve 800) becomes smallest relative to the change in the norm of the solution vector x (see x-axis of the L-Curve 800, e.g., ∥x_{λ}∥). Computation of such a curve demands computing a large number of the residuals (y-axis) and solution norm vectors (x-axis).

An L-Curve tends to be quite complex and it may not always appear as distinct as the L-Curve 800 in FIG. 8. For example, the bend or transition may be less pronounced and, for example, a strictly horizontal (e.g., flat) region may not exist or be readily discernible. As such, generating a number of residuals and solution norms may not necessarily result in being able to discern an optimal value of the Tychonoff parameter λ, for example, by fitting an L-shaped function.

To determine an appropriate value for the Tychonoff parameter λ, a method can include implementing one or more Krylov approximations (e.g., Krylov techniques). Such an approach can allow for generating useful information in an efficient manner (e.g., with reduced computational demands when compared to a guess and check approach).

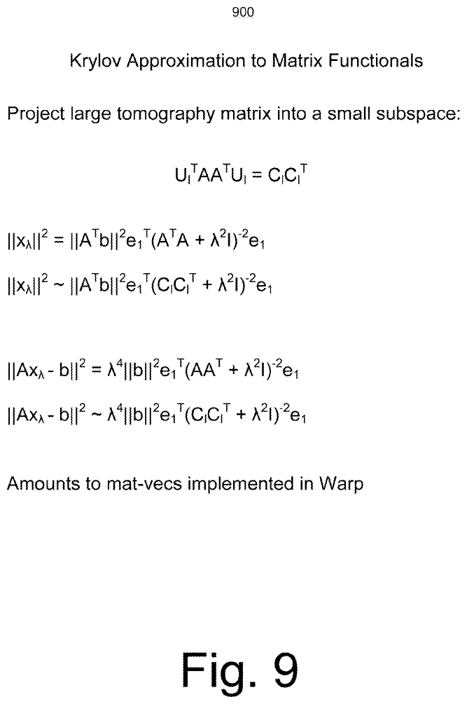

FIG. 9 shows various Krylov approximation to matrix functionals equations 900 for projecting a large tomography matrix into a small subspace. Krylov techniques can provide for estimating a spectrum of an operator to derive approximations to functions of interest, which can be, for example, functions representative of an L-Curve. For example, one function can be an approximation of a residual norm that depends on the Tychonoff parameter λ and another function can be an approximation of a solution norm that depends on the Tychonoff parameter λ. In such an example, while the two functions may be derived through use of a particular value of the Tychonoff parameter λ in a solver, each of the two functions can be utilized to plug in different values for the Tychonoff parameter λ to generate values for the residual norm and the solution norm, which can be assessed to determine an optimal value for the Tychonoff parameter λ that can be utilized in a subsequent run of the solver that can be expected to provide improved results in an efficient manner. Hence, by applying Krylov techniques, approximations to the residual norm and solution norm of a tomography equation can be generated for purposes of estimating an appropriate value for the Tychonoff parameter λ. Such an approach is computationally more efficient than proceeding via a guess and check approach that demands actual computation of a number of residual norm values and a number of solution norm values.

As explained, a solver can implement an LSQR procedure that attempts to solve a system of linear equations (A*x=b) using a least squares technique where the LSQR procedure aims to find a least squares solution for a solution vector x (e.g., x=LSQR(A, b)) that minimizes a norm (e.g., b−A*x). Such an LSQR procedure inverts a rectangular least squares problem.

With reference to FIG. 9, a matrix U is shown, which is implicitly being built through the LSQR procedure; noting that explicitly building the matrix U would be computationally expensive. As shown in FIG. 9, the implicitly built matrix U can be projected onto the norms to provide approximations for determining an appropriate value of the Tychonoff parameter λ. Such an approach is efficient and provides adequate approximations of the norms (e.g., two functions). Hence, points along a curve in an L-space can be approximated efficiently for purposes of determining an appropriate value of the Tychonoff parameter λ.

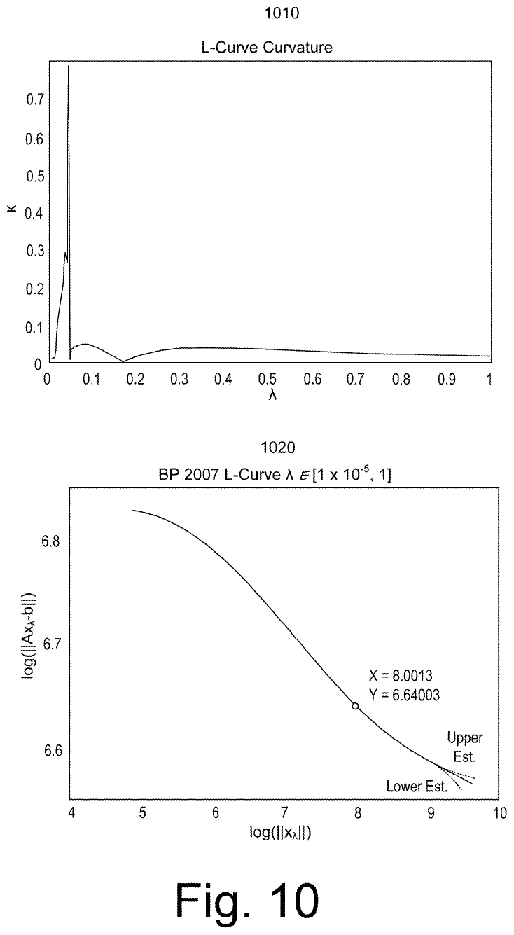

FIG. 10 shows example plots 1010 and 1020 where the plot 1010 shows L-Curve curvature for the L-Curve of the plot 1020. As explained, an L-Curve, in practice, may not appear as distinct as the L-Curve 800 of FIG. 8. For example, the L-Curve of the plot 1020, which is a log-log plot, has a “bend” that is not as distinct as the bend in the L-Curve 800 of FIG. 8 (e.g., in part due to the log-log axes). To determine where the bend is actually located, a method can include performing a curvature analysis to generate results such as the results shown in the plot 1010, which is for curvature with respect to values of the Tychonoff parameter λ; noting that in the plot 1020, values of the Tychonoff parameter λ vary (e.g., consider another dimension along a z-axis that may indicate such values).

As shown in the plot 1010, the curvature of the curve of the plot 1020 is largest at a bend (e.g., a corner), where the spike at approximately 0.04 represents the appropriate value of the Tychonoff parameter λ. As explained, such an approach can be more efficient than a guess and check approach. For example, consider a guess and check approach to the curve of the plot 1020. In such an approach, if five or six points were guessed and checked, there is no guarantee that those five or six points would uncover the point where the curvature is at a maximum. In contrast, by applying a Krylov approximation within an LSQR solver approach, a valuable matrix can be implicitly built and projected to estimate a first function for a residual norm and a second function for a solution vector norm, which, in turn, can provide information for performing a curvature analysis to determine where curvature is the greatest on a curve defined by the first and second functions. The Krylov-based approach, with curvature analysis, can be performed without fitting; whereas, a guess and check approach may demand selection of a function to fit (e.g., another type of guessing involved) the number of residual norm and solution norm values that have been computed. Inherently, the Krylov-based approach, with curvature analysis, is more robust and efficient. As explained, the Krylov-based approach includes projecting the implicitly built matrix Uto two subspaces where each subspace provides one of the functions (e.g., as can be represented by polynomials).

As to the LSQR technique, it is iterative and a Krylov-based approach to determining an appropriate value of the Tychonoff parameter λ can be performed after a specified or determined number of iterations of the LSQR technique. As the number of iterations proceeds, convergence can occur for the approximated functions for the residual norm and the solution norm. Once the appropriate value of the Tychonoff parameter λ is determined, the LSQR technique can be run again with that value. Such an approach can improve convergence of the LSQR technique to an appropriate solution. Such an approach can be utilized in an automated manner to expedite inversion in reflection tomography, which, as explained, may expedite generating a model of a subsurface region (e.g., characterizing the subsurface region via a model that honors properties therein, etc.).

While L-Curve techniques can be applied to various LSQR techniques, the actual values of the Tychonoff parameter λ relate to features of the tomography equations (e.g., per actual physical characteristics of subsurface layers and seismic reflection data) that are driving the null space. Thus, the optimal value of the Tychonoff parameter λ, itself, is a characteristic of the reflection tomography problem, which is a real world, physical and physics-based problem. As an example, for a completely flat reflector in a homogeneous material, the offset equations other than the zero offset equation are redundant. Such that the vertical equation (e.g., zero offset) can be used by itself (e.g., throwing away others but the first row where the first row corresponds to the vertical offset equation). The Tychonoff parameter λ can be a surrogate for the smallest, physically real value of a matrix of a reflection tomography problem, in a scaled sense. As an example, a method can apply to extended image gathers (e.g., angle, offset, etc.), which can include land, marine, land and marine, etc.

As an example, where 4D seismic reflection tomography is performed, a value for a Tychonoff parameter λ determined for one survey can be utilized for inversion of another survey. In such an example, if the value proves unsuitable, that may be an indication that some change has occurred in the geologic environment and/or that some issue exists in acquired seismic data. As an example, Tychonoff parameter λ may be determined locally, for example, for sub-regions of a geologic environment. In such an example, the values may be utilized to characterize differences between the different sub-regions. As an example, a framework may provide for generating output based on Tychonoff parameter values, whether assessed spatially and/or temporally for a region and/or a seismic survey.

As an example, a method can include acquiring seismic data, forming an initial model, migrating the seismic data using the initial model to generate migrated data, forming a tomography operator from migrated data, and using an L-Curve estimation to effectively estimate values of a regularization parameter during LSQR iterations.

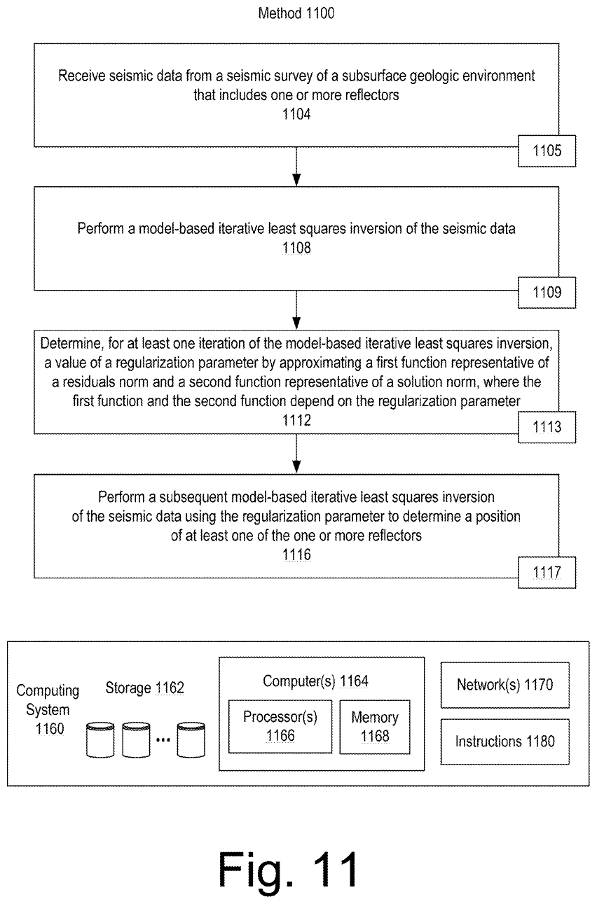

FIG. 11 shows an example of a method 1100 and an example of a system 1160, which may be utilized for performing at least a portion of the method 1100. As shown in FIG. 11, the method 1100 can include a reception block 1104 for receiving seismic data from a seismic survey of a subsurface geologic environment that includes one or more reflectors; a performance block 1108 for performing a model-based iterative least squares inversion of the seismic data; a determination block 1112, for at least one iteration of the model-based iterative least squares inversion, determining a value of a regularization parameter by approximating a first function representative of a residuals norm and a second function representative of a solution norm, where the first function and the second function depend on the regularization parameter; and a performance block 1116 for performing a subsequent model-based iterative least squares inversion of the seismic data using the regularization parameter to determine a position of at least one of the one or more reflectors.

The method 1100 is shown in FIG. 11 in association with various computer-readable media (CRM) blocks 1105, 1109, 1113 and 1117. Such blocks generally include instructions suitable for execution by one or more processors (or cores) to instruct a computing device or system to perform one or more actions. While various blocks are shown, a single medium may be configured with instructions to allow for, at least in part, performance of various actions of the method 1100 (e.g., using the computing system 1160, etc.). A computer-readable medium (CRM) may be a computer-readable storage medium that includes, but is not limited to a carrier wave, a signal, and a non-transitory medium.

FIG. 11 shows the computing system 1160 as including one or more information storage devices 1162, one or more computers 1164, one or more network interfaces 1170 and instructions 1180. As to the one or more computers 1164, each computer may include one or more processors (or processing cores) 1166 and memory 1168 for storing instructions executable by at least one of the one or more processors. A computer may include one or more network interfaces (wired or wireless), one or more graphics cards, a display interface (wired or wireless), etc. A system may include one or more display devices (optionally as part of a computing device, etc.). Memory can be a computer-readable storage medium. A computer-readable storage medium is not a carrier wave, is not a signal and is non-transitory.

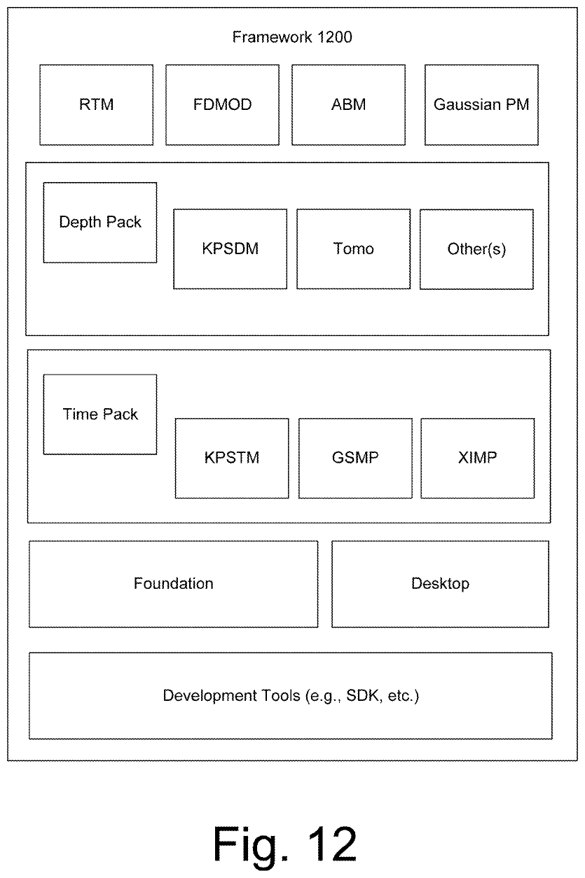

FIG. 12 shows an example of a computational framework 1200 that can include one or more processors and memory, as well as, for example, one or more interfaces. The blocks of the computational framework 1200 may be provided as instructions (e.g., the instructions 1180 of the system 1160 of FIG. 11, etc.). The computational framework of FIG. 12 can include one or more features of the OMEGA framework, which includes finite difference modelling (FDMOD) features for two-way wavefield extrapolation modelling, generating synthetic shot gathers with and without multiples. The FDMOD features can generate synthetic shot gathers by using full 3D, two-way wavefield extrapolation modelling, which can utilize wavefield extrapolation logic matches that are used by reverse-time migration (RTM). A model may be specified on a dense 3D grid as velocity and optionally as anisotropy, dip, and variable density.

As shown in FIG. 12, the computational framework 1200 includes features for RTM, FDMOD, adaptive beam migration (ABM), Gaussian packet migration (Gaussian PM), depth processing (e.g., Kirchhoff prestack depth migration (KPSDM), tomography (Tomo)), time processing (e.g., Kirchhoff prestack time migration (KPSTM), general surface multiple prediction (GSMP), extended interbed multiple prediction (XIMP)), framework foundation features, desktop features (e.g., GUIs, etc.), and development tools.

The framework 1200 can include features for geophysics data processing. The framework 1200 can allow for processing various types of data such as, for example, one or more of: land, marine, and transition zone data; time and depth data; 2D, 3D, and 4D surveys; isotropic and anisotropic (TTI and VTI) velocity fields; and multicomponent data.

The framework 1200 can allow for transforming seismic, electromagnetic, microseismic, and/or vertical seismic profile (VSP) data into actionable information, for example, to perform one or more actions in the field for purposes of resource production, etc. The framework 1200 can extend workflows into reservoir characterization and earth modelling. For example, the framework 1200 can extend geophysics data processing into reservoir modelling by integrating with the PETREL framework via the Earth Model Building (EMB) tools, which enable a variety of depth imaging workflows, including model building, editing and updating, depth-tomography QC, residual moveout analysis, and volumetric common-image-point (CIP) pick QC. Such functionalities, in conjunction with depth tomography and migration algorithms of the framework 1200 can produce accurate and precise images of the subsurface. The framework 1200 may provide support for field to final imaging, to prestack seismic interpretation and quantitative interpretation, from exploration to development.

As an example, the FDMOD component can be instantiated via one or more CPUs and/or one or more GPUs for one or more purposes. For example, consider utilizing the FDMOD for generating synthetic shot gathers by using full 3D, two-way wavefield extrapolation modelling, the same wavefield extrapolation logic matches that are used by RTM. FDMOD can model various aspects and effects of wave propagation. The output from FDMOD can be or include synthetic shot gathers including direct arrivals, primaries, surface multiples, and interbed multiples. The model can be specified on a dense 3D grid as velocity and optionally as anisotropy, dip, and variable density. As an example, survey designs can be modelled to ensure quality of a seismic survey, which may account for structural complexity of the model. Such an approach can enable evaluation of how well a target zone will be illuminated. Such an approach may be part of a quality control process (e.g., task) as part of a seismic workflow. As an example, a FDMOD approach may be specified as to size, which may be model size (e.g., a grid cell model size). Such a parameter can be utilized in determining resources to be allocated to perform a FDMOD related processing task. For example, a relationship between model size and CPUs, GPUs, etc., may be established for purposes of generating results in a desired amount of time, which may be part of a plan (e.g., a schedule) for a seismic interpretation workflow.

As an example, as survey data become available, interpretation tasks may be performed for building, adjusting, etc., one or more models of a geologic environment. For example, consider a vessel that transmits a portion of acquired data while at sea and that transmits a portion of acquired data while in port, which may include physically offloading one or more storage devices and transporting such one or more storage devices to an onshore site that includes equipment operatively coupled to one or more networks (e.g., cable, etc.). As data are available, options exist for tasks to be performed.

As an example, the framework 1200 can include one or more sets of instructions executable to perform one or more methods (e.g., consider the method 1100 of FIG. 11).

As an example, a method can include receiving seismic data from a seismic survey of a subsurface geologic environment that includes one or more reflectors; performing a model-based iterative least squares inversion of the seismic data; for at least one iteration of the model-based iterative least squares inversion, determining a value of a regularization parameter by approximating a first function representative of a residuals norm and a second function representative of a solution norm, where the first function and the second function depend on the regularization parameter; and performing a subsequent model-based iterative least squares inversion of the seismic data using the regularization parameter to determine a position of at least one of the one or more reflectors. In such an example, the seismic data can be or include migrated seismic data.

As an example, a method can include determining a value of a regularization parameter at least in part by using an L-Curve estimation.

As an example, a method can include determining a value of a regularization parameter at least in part by plugging a number of values for the regularization parameter into first and second functions to generate a curve. In such an example, the method can include determining a point on the curve that corresponds to a maximum in curvature. In such an example, the point can correspond to the value of the regularization parameter.

As an example, a method can include approximating a first function representative of a residuals norm and a second function representative of a solution norm includes applying a Krylov technique.

As an example, a regularization parameter can be a Tychonoff parameter.

As an example, a regularization parameter can be a parameter with a range from zero to unity.

As an example, a regularization parameter can account for effective null space.

As an example, a regularization parameter can characterize a subsurface geologic environment with respect to seismic data. As an example, a number of regularization parameters may be determined for different regions of a seismic survey where each characterizes one of the different regions. As an example, a 4D survey may utilize the regularization parameters for surveys taken at different times over a 3D region in space. As an example, a method can include tailoring a survey based at least in part on a value of a regularization parameter (e.g., from a prior survey).

As an example, a value of a regularization parameter can improve performance of a subsequent model-based iterative least squares inversion of seismic data.

As an example, a seismic survey can be an extended image gathers survey, an offset-based survey, an angle-based survey, a common image point survey, etc.

As an example, a subsurface geologic environment can include at least one salt structure.

As an example, a subsequent model-based iterative least squares inversion can generate a model that includes representations of one or more reflectors and material properties values for a subsurface geologic environment.

As an example, a system can include a processor; memory operatively coupled to the processor; and processor-executable instructions stored in the memory to instruct the system to: receive seismic data from a seismic survey of a subsurface geologic environment that includes one or more reflectors; perform a model-based iterative least squares inversion of the seismic data; for at least one iteration of the model-based iterative least squares inversion, determine a value of a regularization parameter by approximating a first function representative of a residuals norm and a second function representative of a solution norm, where the first function and the second function depend on the regularization parameter; and perform a subsequent model-based iterative least squares inversion of the seismic data using the regularization parameter to determine a position of at least one of the one or more reflectors.

As an example, one or more computer-readable storage media can include computer-executable instructions executable to instruct a computing system to: receive seismic data from a seismic survey of a subsurface geologic environment that includes one or more reflectors; perform a model-based iterative least squares inversion of the seismic data; for at least one iteration of the model-based iterative least squares inversion, determine a value of a regularization parameter by approximating a first function representative of a residuals norm and a second function representative of a solution norm, where the first function and the second function depend on the regularization parameter; and perform a subsequent model-based iterative least squares inversion of the seismic data using the regularization parameter to determine a position of at least one of the one or more reflectors.

As an example, a computer program product can include computer-executable instructions to instruct a computing system to perform a method, for example, consider a method such as the method 1100 of FIG. 11, etc.

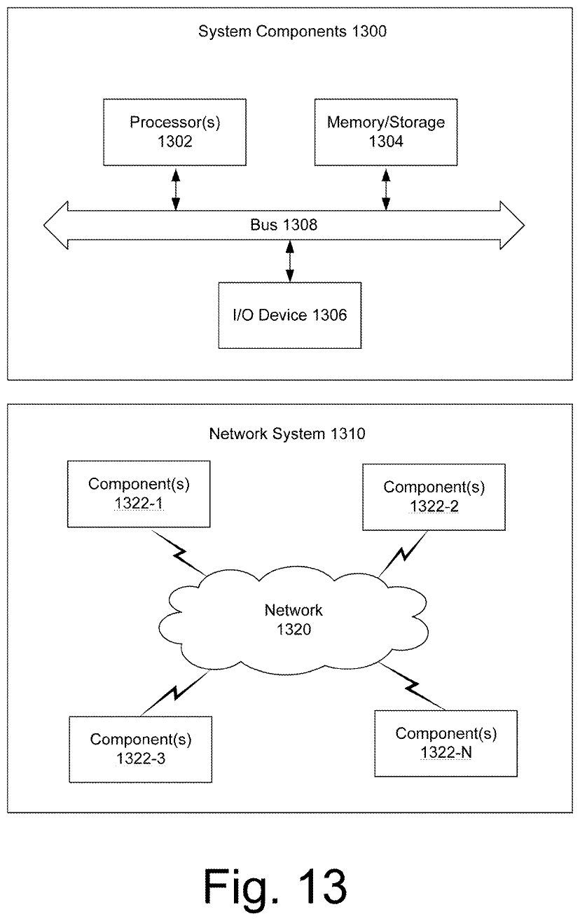

FIG. 13 shows components of a computing system 1300 and a networked system 1310 that includes a network 1320. The system 1300 includes one or more processors 1302, memory and/or storage components 1304, one or more input and/or output devices 1306 and a bus 1308. Instructions may be stored in one or more computer-readable media (memory/storage components 1304). Such instructions may be read by one or more processors (see the processor(s) 1302) via a communication bus (see the bus 1308), which may be wired or wireless. The one or more processors may execute such instructions to implement (wholly or in part) one or more attributes (as part of a method). A user may view output from and interact with a process via an I/O device (see the device 1306). A computer-readable medium may be a storage component such as a physical memory storage device such as a chip, a chip on a package, a memory card, etc. (a computer-readable storage medium).

Components may be distributed, such as in the network system 1310. The network system 1310 includes components 1322-1, 1322-2, 1322-3, . . . 1322-N. The components 1322-1 may include the processor(s) 1302 while the component(s) 1322-3 may include memory accessible by the processor(s) 1302. Further, the component(s) 1322-2 may include an I/O device for display and optionally interaction with a method. The network may be or include the Internet, an intranet, a cellular network, a satellite network, etc.

A device may be a mobile device that includes one or more network interfaces for communication of information. A mobile device may include a wireless network interface (operable via IEEE 802.11, ETSI GSM, BLUETOOTH®, satellite, etc.). A mobile device may include components such as a main processor, memory, a display, display graphics circuitry (optionally including touch and gesture circuitry), a SIM slot, audio/video circuitry, motion processing circuitry (accelerometer, gyroscope), wireless LAN circuitry, smart card circuitry, transmitter circuitry, GPS circuitry, and a battery. A mobile device may be configured as a cell phone, a tablet, etc. A method may be implemented (wholly or in part) using a mobile device. A system may include one or more mobile devices.

A system may be a distributed environment such as a so-called “cloud” environment where various devices, components, etc. interact for purposes of data storage, communications, computing, etc. A device or a system may include one or more components for communication of information via one or more of the Internet (where communication occurs via one or more Internet protocols), a cellular network, a satellite network, etc. A method may be implemented in a distributed environment (wholly or in part as a cloud-based service).

Information may be input from a display (consider a touchscreen), output to a display or both. Information may be output to a projector, a laser device, a printer, etc. such that the information may be viewed. Information may be output stereographically or holographically. As to a printer, consider a 2D or a 3D printer. A 3D printer may include one or more substances that can be output to construct a 3D object. Data may be provided to a 3D printer to construct a 3D representation of a subterranean formation. Layers may be constructed in 3D (horizons, etc.), geobodies constructed in 3D, etc. Holes, fractures, etc., may be constructed in 3D (as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving seismic data from a seismic survey of a subsurface geologic environment that includes one or more reflectors;
performing a model-based iterative least squares inversion of the seismic data;
for at least one iteration of the model-based iterative least squares inversion, determining a value of a regularization parameter by approximating a first function representative of a residuals norm and a second function representative of a solution norm, wherein the first function and the second function depend on the regularization parameter; and
performing a subsequent model-based iterative least squares inversion of the seismic data using the regularization parameter to determine a position of at least one of the one or more reflectors.

2. The method of claim 1, wherein the seismic data include migrated seismic data.

3. The method of claim 1, wherein the determining the value of the regularization parameter includes using an L-Curve estimation.

4. The method of claim 1, wherein the determining the value of the regularization parameter includes plugging a number of values for the regularization parameter into the first and second functions to generate a curve.

5. The method of claim 4, comprising determining a point on the curve that corresponds to a maximum in curvature.

6. The method of claim 5, wherein the point corresponds to the value of the regularization parameter.

7. The method of claim 1, wherein approximating the first function representative of the residuals norm and the second function representative of the solution norm includes applying a Krylov technique.

8. The method of claim 1, wherein the regularization parameter is a Tychonoff parameter.

9. The method of claim 1, wherein the regularization parameter includes a range from zero to unity.

10. The method of claim 1, wherein the regularization parameter accounts for effective null space.

11. The method of claim 1, wherein the regularization parameter characterizes the subsurface geologic environment with respect to the seismic data.

12. The method of claim 1, wherein the value of the regularization parameter improves performance of the subsequent model-based iterative least squares inversion of the seismic data.

13. The method of claim 1, wherein the seismic survey includes an extended image gathers survey.

14. The method of claim 1, wherein the seismic survey includes an offset-based survey.

15. The method of claim 1, wherein the seismic survey includes an angle-based survey.

16. The method of claim 1, wherein the seismic survey includes a common image point survey.

17. The method of claim 1, wherein the subsurface geologic environment includes at least one salt structure.

18. The method of claim 1, wherein the subsequent model-based iterative least squares inversion generates a model that includes representations of the one or more reflectors and material properties values for the subsurface geologic environment.

19. A system comprising:
a processor;
memory operatively coupled to the processor; and
processor-executable instructions stored in the memory to instruct the system to:
receive seismic data from a seismic survey of a subsurface geologic environment that includes one or more reflectors;
perform a model-based iterative least squares inversion of the seismic data;
for at least one iteration of the model-based iterative least squares inversion, determine a value of a regularization parameter by approximating a first function representative of a residuals norm and a second function representative of a solution norm, wherein the first function and the second function depend on the regularization parameter; and
perform a subsequent model-based iterative least squares inversion of the seismic data using the regularization parameter to determine a position of at least one of the one or more reflectors.

20. One or more computer-readable storage media comprising computer-executable instructions executable to instruct a computing system to:
receive seismic data from a seismic survey of a subsurface geologic environment that includes one or more reflectors;
perform a model-based iterative least squares inversion of the seismic data;
for at least one iteration of the model-based iterative least squares inversion, determine a value of a regularization parameter by approximating a first function representative of a residuals norm and a second function representative of a solution norm, wherein the first function and the second function depend on the regularization parameter; and
perform a subsequent model-based iterative least squares inversion of the seismic data using the regularization parameter to determine a position of at least one of the one or more reflectors.
